(19) United States
(12) Patent Application Publication
(10) Pub. No.: US 2005/0232723 A1
(43) Pub. Date: Oct. 20, 2005

(54) Fastener for use in adverse environmental conditions

(75) Inventors: Richard J. Dalidowitz, Berlin, CT (US); Edward G. Sutt JR., Jamestown, RI (US); August A. Reinhardt, East Greenwich, RI (US)

Correspondence Address: PILLSBURY WINTHROP SHAW PITTMAN, LLP, P.O. BOX 10500, MCLEAN, VA, 22102, US

(73) Assignee: STANLEY FASTENING SYSTEMS, L.P., East Greenwich, RI (US)

(21) Appl. No.: 10/825,168

(22) Filed: Apr. 16, 2004

(51) Int. Cl. F16B 15/00

(52) U.S. Cl. 411/487

(57) ABSTRACT

A package of collated galvanized carbon steel fasteners suitable for use in adverse environmental conditions is disclosed. The package includes a plurality of fasteners and an attachment structure. Each fastener includes a carbon steel head that has a top surface suitable for being driven into a flush relationship with a substrate, and a bottom head surface that contacts the substrate. Each fastener also includes a single carbon steel elongate shank that is integral with the head, extends from the bottom head surface, and includes a tip opposite the head. Each fastener further includes an electrodeposited coating that is deposited directly on a surface of the carbon steel head and shank. The electrodeposited coating includes zinc and has an average thickness of greater than about 1.0 mil. The top surface of the carbon steel head is textured to improve adhesion between that electrodeposited coating and the top surface.

### BACKGROUND OF THE INVENTION

1. Field of the Invention

The present invention is generally related to fasteners and more particularly to galvanized carbon steel fasteners that are suitable for use in adverse environmental conditions.

2. Description of Related Art

A steel fastener that is subjected to adverse environmental conditions such as moisture, pressure treatment chemicals, salt air, or acid rain is likely to rust or corrode. In the process, the material and the properties of the fastener are ultimately destroyed. For corrosion to occur, certain elements are necessary so that a corrosion cell exists. These elements are an anode, a cathode, an electrolyte or conductive solution around the metal, and the metal itself. In most corrosion cells, oxygen is also present. The electrochemical nature of this corrosion reaction involves the transfer of electrons from an anode site on the metal to a cathode. In the typical corrosion reaction, there is an oxidation reaction that occurs at the anode as well as a reduction reaction that occurs at the cathode site. These are commonly referred to as half reactions. The anodic reaction consumes the metal and generates metal ions and electrons, which move through the electrolyte solution to the cathode and are ultimately consumed. Temperature affects the rate or speed of this reaction and rust formation.

The half reactions of steel rusting in the presence of moisture and oxygen can be expressed as follows:
Oxidation (anodic reaction): Fe→Fe⁺²+2e
Reduction (cathodic reaction): O₂+H₂O+4e→4 OH⁻
These two half reactions can be combined to show the total reaction:
2Fe+2 H₂O+O₂→2Fe⁺²+4OH⁻→2 Fe(OH)₂ ↓
The ferrous hydroxide (Fe(OH)₂) precipitates from solution and is unstable in air. It therefore oxidizes to form the ferric salt:
2 Fe(OH)₂+H₂O+½ O₂→2 Fe(OH)₃
The final product is commonly referred to as rust.

The most common way to prevent corrosion or rust on steel is to provide a protective layer or deposit with an oxidation potential which will allow this layer to serve as the anode of the corrosion cell. This is referred to as galvanic coupling. The anode functions as part of a galvanic coupling cell with the steel base of the fastener now acting as the cathode. This approach is known as cathodic protection. The protective layer, now acting as the anode, preferentially corrodes, thereby protecting the base steel material. One of the most commonly used protecting layers or deposits for steel is zinc. Zinc protects steel because it is less noble (more reactive) than the steel and sacrifices itself for the steel in the corrosive environment. It provides protection until it is consumed in the corrosion cell and the base metal is exposed. At this point, the steel will begin to corrode as it normally would in the corrosion cell. Because the zinc protective layer is sacrificial, it does have a finite lifespan. For these reasons, stainless steel is often used in corrosive environments because it is more noble (less reactive) than steel. However, stainless steel is more expensive than steel, even with a coating, and is thus not practical to use as a fastener material in all applications.

There are three processes to apply zinc to a fastener: mechanical galvanization, hot dipped galvanization, and electrodeposition. With mechanical galvanization, the fasteners are typically placed in a barrel with zinc dust or particles, media, and proprietary chemicals. The barrel is rotated until the desired amount of zinc is deposited on the fasteners. The ASTM standard for this process is B 695, hereby incorporated by reference in its entirety, which defines coating classes with thicknesses ranging from 0.2 mil to 4.2 mils. The ASTM standard refers to mechanical galvanization with and without chromate coatings. A chromate coating is a supplementary coating disposed over zinc that provides additional protection against the onset of corrosion by passivating the zinc surface or making it less reactive.

With hot dipped galvanization, the fasteners are placed in a basket with holes and deposited in a vat of molten zinc. The fasteners are then removed, spun and then dipped and spun a second time. The ASTM standard for this process is A 153, hereby incorporated by reference in its entirety, which defines a minimum coating thickness of 1.4 mils on any individual sample for fasteners less than 0.375 inches in diameter. Hereinafter, reference to hot dipped galvanized refers to fasteners that meet the zinc coating thickness of ASTM A 153.

Electrodeposition, or electroplating, uses an electrical current to drive the zinc through a conductive solution to the fasteners. Electrodeposition provides coatings that are more uniform, yet more brittle, than coatings applied via mechanical galvanization or hot dipped galvanization. The ASTM standard for electrodeposited coatings of zinc on iron and steel is B 633, hereby incorporated by reference in its entirety, which defines coating classes from 0.2 mil to 1.0 mil. Thus, the ASTM standard for electrodeposited zinc only defines a thickness that is about, at most, 70 percent of the minimum requirement for hot dipped, i.e., 1.0 mil versus 1.4 mils. The ASTM standard refers to electrodeposited coatings with and without a chromate coating.

Historically, hot dipped galvanized fasteners have been recommended by the building codes and the pressure treatment formulators for use in pressure treated wood largely due to the thicker zinc layer and the sacrificial nature of zinc. Fasteners with electrodeposited zinc coatings have typically not been accepted by the building codes for use in exterior applications.

The primary method to pressure treat wood has been with chromated copper arsenate (“CCA”). The pressure treated wood industry voluntarily agreed to remove the arsenic from the formulations as of Jan. 1, 2004. This has resulted in several different treatment formulations, the most common being ammoniacal copper quat (“ACQ”) and copper boron azole (“CBA”). However, both of these formulations have been shown by the standard industry test, AWPA E 12, to be more corrosive than the original CCA formulations.

There is a need in the industry to provide a galvanized steel fastener with a more uniform coating that can perform as well as or better than the industry-recommended hot dipped galvanized steel fasteners.

### SUMMARY OF THE INVENTION

Until now, it was thought that carbon steel fasteners with electrodeposited coatings with thicknesses outside of the range provided for in the ASTM standard were not commercially viable. It has been found that by optimizing the electrodeposition process by improving the efficiency of the bath used, by varying the composition of the bath, by lengthening the time the fastener is in the bath, and by optimizing the amperage used, coatings of greater than 1.0 mil are commercially viable. It has also been found that by texturing the top surfaces of the heads of the fasteners, the adhesion of the electrodeposited coating to the heads is improved to the extent that fasteners can be driven by a tool without impairing the integrity of the coating.

It is one aspect of the invention to provide a galvanized carbon steel fastener with an electrodeposited coating of a suitable thickness that performs as well as or better than the existing hot dipped galvanized steel fasteners in adverse environmental conditions.

According to at least one embodiment of the invention, a galvanized carbon steel fastener that is suitable for use in adverse environmental conditions is provided. The fastener includes a head that has a top surface that is suitable for being driven into a flush relationship with an exterior surface of a substrate, and a bottom surface for engaging the exterior surface of the substrate. The fastener also includes a single elongate shank that is integral with the head and extends from the bottom surface of the head. The shank includes a tip opposite the head. The head and integral shank are formed from carbon steel. The fastener also includes an electrodeposited coating that is deposited directly on a surface of the carbon steel head and shank. The electrodeposited coating includes zinc and has an average thickness of greater than about 1.0 mil. The top surface of the carbon steel head is textured to improve adhesion between the electrodeposited coating and the top surface.

The fastener may further include a second coating that includes chromate and is deposited on the electrodeposited coating. The average thickness of the second coating is less than about 0.05 mil.

The fastener may further include a plurality of surface deformations formed on the shank. The surface deformations may include a plurality of flutes that extend radially outwardly from the shank. Alternatively, the surface deformations may include a plurality of rings that extend radially outwardly from the shank. Alternatively, the surface deformations may include a combination of a plurality of flutes and a plurality of rings that extend radially outwardly from the shank.

It is another aspect of the invention to provide a combination of at least one piece of pressure treated wood and a galvanized carbon steel fastener with an electrodeposited coating, whereby the fastener performs as well as or better than existing hot dipped galvanized steel fasteners when used in attaching pressure treated wood to another structure.

In at least one embodiment, a combination of at least one piece of pressure treated wood and a galvanized carbon steel fastener is provided. The fastener includes a head that has a top surface that is suitable for being driven into a flush relationship with an exterior surface of a substrate, and a bottom surface for engaging the exterior surface of the substrate. The fastener also includes a single elongate shank that is integral with the head and extends from the bottom surface of the head. The shank includes a tip opposite the head. The head and integral shank are formed from carbon steel. The fastener also includes an electrodeposited coating that is deposited on a surface of the carbon steel head and shank. The electrodeposited coating includes zinc and has an average thickness of greater than about 1.0 mil. The top surface of the carbon steel head is textured to improve adhesion between the electrodeposited coating and the top surface.

It is another aspect of the invention to provide a package of collated galvanized steel fasteners with electrodeposited coatings, whereby the fasteners perform as well as or better than existing hot dipped galvanized carbon steel fasteners in adverse environmental conditions.

In at least one embodiment, a package of collated galvanized carbon steel fasteners suitable for use in adverse environmental conditions is provided. The package includes a plurality of fasteners and an attachment structure that is constructed and arranged to temporarily attach the plurality of fasteners into the package in which the fasteners are in collated relation. Each fastener includes a head that has a top surface that is suitable for being driven into a flush relationship with a substrate, and a bottom head surface that contacts the substrate. Each fastener also includes a single elongate shank that is integral with the head and extends from the bottom head surface. The elongate shank includes a tip opposite the head. The head and integral shank are formed from carbon steel. Each fastener further includes an electrodeposited coating that is deposited directly on the carbon steel head and shank. The electrodeposited coating includes zinc and has an average thickness of greater than about 1.0 mil. The top surface of the carbon steel head is textured to improve adhesion between the electrodeposited coating and the top surface.

These and other aspects of the invention will become apparent from the following detailed description when taken in conjunction with the accompanying drawings, which are part of this disclosure and which illustrate, by way of example, the principles of this invention.

### BRIEF DESCRIPTION OF THE DRAWINGS

Features of the invention are shown in the drawings, in which like reference numerals designate like elements. The drawings form part of this original disclosure, in which:

FIG. 1 is a side view of a fastener according to one embodiment of the invention, with portions of two coatings removed;

FIG. 2 is an enlarged cross-sectional view of the fastener of FIG. 1 along line II-II;

FIG. 3 is an enlarged top view of the fastener of FIG. 1;

FIG. 4 is a side view of the fastener of FIG. 1 after it has been driven into pressure treated wood;

FIG. 5 is a side view of a collation of fasteners according to an embodiment of the invention;

FIG. 6 is a side view of another collation of fasteners according to the invention;

FIG. 7 is a side view of another type of fastener according to the invention;

FIG. 8 is a graphical representation of results from an ASTM B 117 salt spray test; and

FIG. 9 is a graphical representation of results from a driven fastener ASTM B 117 salt spray test.

### DETAILED DESCRIPTION OF EMBODIMENTS OF THE INVENTION

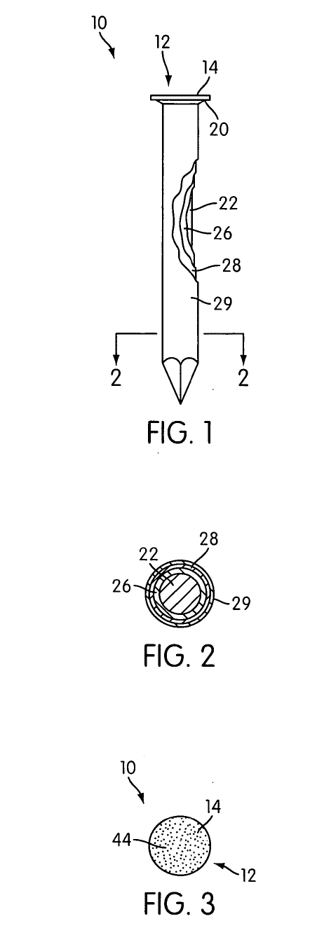

FIG. 1 shows one embodiment of the present invention in which a galvanized carbon steel fastener 10 that is suitable for use in adverse environmental conditions is provided. It is understood that adverse environmental conditions means that conditions exist for the steel to corrode or rust, and include but are not limited to moist environments, salt environments, and environments that include CCA, ACQ, and/or CBA, as defined above.

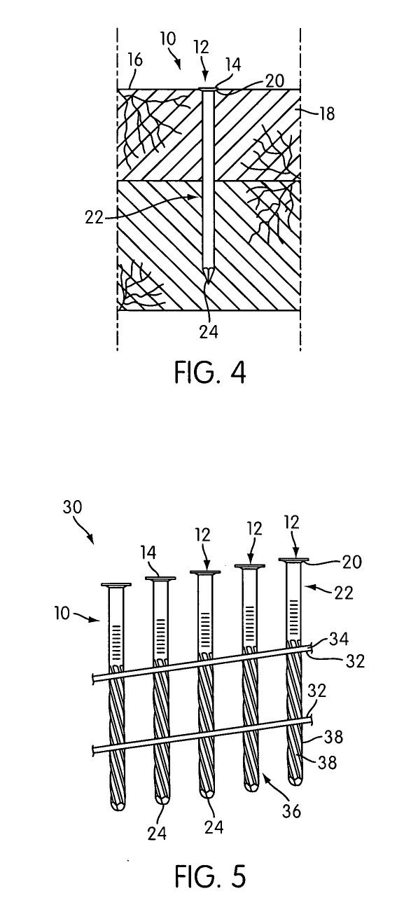

The fastener 10 is preferably formed from an industrial grade carbon steel alloy, and includes a head 12 that has a top surface 14 that is suitable for being driven into a flush relationship with an exterior surface 16 of a substrate 18, as shown in FIG. 4. The substrate 18 may be a piece of pressure treated wood that includes CCA, ACQ, or CBA. The head 12 also has a bottom surface 20 for engaging the exterior surface 16 of the substrate 18. Preferably, the head 12 is substantially round, although it may be any shape suitable for a fastener. The fastener 10 further includes a single elongated shank 22 that is integral with the head 12 and extends from the bottom surface 20 of the head 12. The shank 22 includes a tip 24 that is opposite the head 12. The tip 24 may be of a point or a blunt configuration.

As shown in FIGS. 1 and 2, the fastener 10 further includes an electrodeposited zinc coating 26 that is deposited on at least a portion of the surface of the carbon steel head 12 and shank 22, and has an average thickness of greater than about 1.0 mil, which is above the ASTM standard. The average thickness of the coating 26 is preferably from about 1.2 mils to about 2.0 mils. Preferably, the zinc coating 26 is deposited on the entire surface of the head 12 and the shank 22.

To achieve these thicknesses that are above the ASTM standard, the electrodeposition process was optimized by improving the efficiency of the bath used, by increasing the amount if zinc in the bath, by optimizing the carrier used in the bath, by lengthening the time the fastener is in the bath, and by optimizing the amperage used. After optimization, it was found that a coating of about 0.5 mil in thickness could be applied in 33% less time.

The fastener 10 may also include a layer of chromate 28 that is applied on the outside of the electrodeposited coating 26 by a dipping process. After the fastener is removed from the bath, it is rinsed with a nitric acid solution and then dipped in a chromate solution. The thickness of the chromate layer 28 is less than about 0.1 mil. In a preferred embodiment, the thickness of the chromate layer 28 generally does not exceed about 0.05 mil, and typically is in the range of about 0.01 mil to about 0.05 mil. The fastener 10 may also include a polymeric coating 29 that is deposited on the-layer of chromate 28, as shown in FIGS. 1 and 2.

The fasteners 10 may be collated together into a package 30 of fasteners 10 with an attachment structure 32, as shown in FIG. 5. The attachment structure 32 is constructed and arranged to temporarily attach the plurality of fasteners 10 together such that the fasteners 10 are in a collated relation. As shown, the collated relation is a parallel substantially longitudinally coextensive relation. Preferably, the attachment structure 32 includes at least one fragible wire 34 that is welded to the shank 22 of each fastener 10 of the package 30. It has been found that the more uniform coating provided by the electrodeposition process allows for a better quality weld, thereby allowing the fasteners 10 to stay in a collated relation until each fastener 10 is driven into the substrate 18. The strengths of the wire 34 and the weld are such that they are strong enough to keep the fasteners 10 in a collated relation, yet are able to be broken by a shearing force when a lead fastener of the package 30 is driven by a tool.

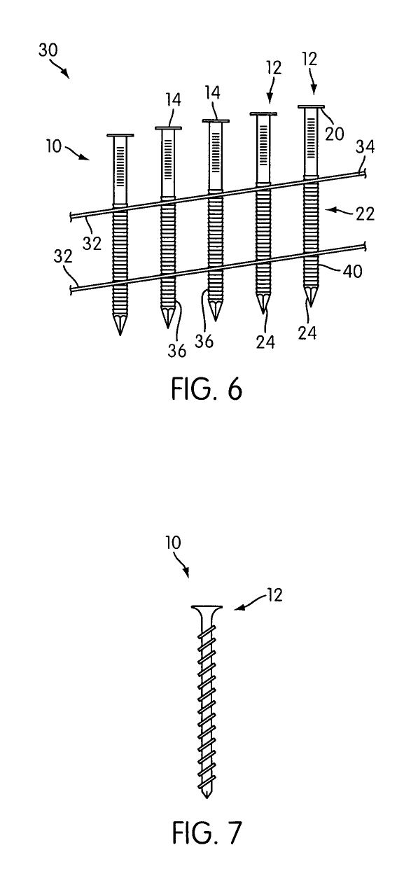

As shown in FIG. 5, the shank 22 of the fastener 10 may include surface deformations 36. The surface deformations 36 may include spiral deformations 38 that extend radially outwardly from the shank 22, as shown in FIG. 5, or may include rings 40 that extend radially outwardly from the shank 22, as shown in FIG. 6. It is also contemplated that the surface deformations 36 may include both spiral deformations 38 and rings 40 that extend radially outwardly from the shank 22. Although the embodiments shown in FIGS. 1-6 show the fastener 10 being a nail, it is also contemplated that the fastener 10 may be a screw 42, as shown in FIG. 7, or any other type of steel fastener that may be subjected to adverse environmental conditions.

Testing

There is no standard test protocol at this time for the evaluation of fasteners in pressure treated wood. Therefore, to evaluate fasteners and their coatings for use in pressure treated wood, three tests were created using existing protocols and modifying them to simulate end use conditions.

The first test was a salt spray test per ASTM B 117, incorporated herein by reference in its entirety. This test evaluated the corrosion resistance of a fastener when subjected to a salt environment in its undriven state.

In the second test, the fasteners were flush driven into pressure treated wood and then subjected to the ASTM B117 test. This test evaluated the performance of the fasteners when subject to the impact of installation, and the configuration simulated the fasteners on a coastal deck.

The third test performed was the AWPA E12 test, incorporated herein by reference in its entirety. This test is designed to project the long term performance of metals in contact with pressure treated wood. In this test, the fasteners were sandwiched in pressure treated wood and subjected to a high humidity and temperature environment. At periodic increments, the fasteners were weighed, cleaned, and compared to the weight at the start of the test.

All of these tests were subject to considerable variability due to the wood and the testing environment. Therefore, all of the tests were performed in a comparative manner.

The initial trials attempted to duplicate the same zinc level as hot dipped, i.e. at least 1.4 mils. However, it was found that the increased zinc thickness on the head created a condition where the zinc would chip off the head of the fastener while being driven with a pneumatic tool.

Therefore, a production adhesion test was developed to simulate the forces of driving the fastener. The adhesion test had two components: static and dynamic. The static test applied a 1900 pound load to the head of the fastener with a wedge shaped chisel. The impact test applied a 72 inch pound impact force to the head of the fastener with a wedge shaped chisel. The two tests were roughly correlated to a tool driving a 0.120″×3′ fastener into oak. The chipping of the zinc coating was not desirable because if the base metal was exposed, the service life of the fastener may be reduced. Further, fasteners with this level of zinc were difficult to weld, had increased variability, and extended the pound per hour output beyond the steady state demand for galvanized fasteners.

Because of capacity constraints, variability, welding issues, and chipping, the target average zinc thickness was then reduced to a range of 1.2 to 1.4 mils. After trials occurred at this target thickness, it was found that chipping still occurred. Fasteners were then made with textured heads 44, as shown in FIG. 2, and plated in the exact same conditions as fasteners without textured heads. The fasteners with and without the head texturing were tested with both the static and impact adhesion tests. The results showed that none of the fasteners with textured heads chipped, while more than half of the fasteners without textured heads exhibited at least some chipping. Thus, in the preferred embodiment, the fasteners 10 include textured heads 44.

As mentioned above, hot dipped galvanized fasteners do not have chromate layer for additional performance. The background testing of electrodeposited fasteners with a chromate coating showed an equivalence to a hot dipped galvanized fastener at the following approximate average thicknesses: B 117 Salt spray: 0.6 mil, Driven B 117 Salt Spray: 1.2 mils, and AWPA E 12: 0.75 mil.

ASTM B 117 Salt Spray Results

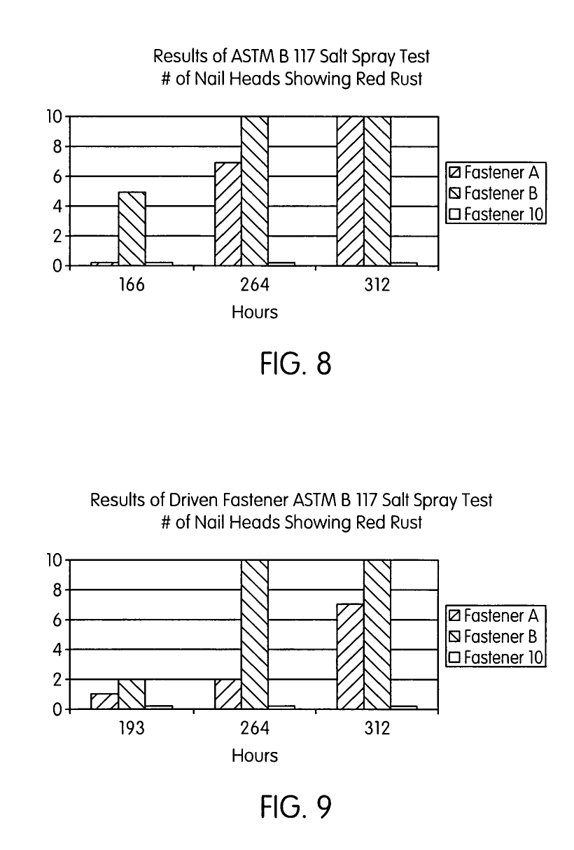

Randomly sampled fasteners 10 and two major competitors' hot dipped galvanized fasteners, fastener A and fastener B, were sent to a third party building code recognized laboratory (RADCO) for evaluation in direct salt exposure. Ten fasteners from each sample set were tested. The results, shown in FIG. 8, showed that after 312 hours, all of the competitive hot dipped galvanized fasteners displayed red rust (larger than 1 mm²), while the fasteners 10 in accordance with the invention showed no rust.

Internal testing has had fasteners 10 in salt spray for up to 1450 hours without any red rust. It is typically understood that over 1000 hours of salt spray resistance is exceptional. As noted above, these tests have many variables so comparing the results from the third party tests to the internal tests would not be accurate. Internal testing with another group of samples by the same manufacturers showed the fasteners 10 performing equally with no red corrosion to the competitor's product A after 800 hours in direct salt exposure. In the same test, one of the competitor's product B showed red rust after 600 hours. The conclusion from the internal and third party salt spray results is that the fasteners 10 in accordance with the invention surprisingly perform as well as or better than the hot dipped galvanized fasteners.

Driven Fastener ASTM B 117 Salt Spray Results

Randomly sampled fasteners 10 and two major competitors' hot dipped galvanized fasteners, fastener A and fastener B, were sent to a third party building code recognized laboratory (RADCO) for evaluation in direct salt exposure after the fasteners were driven into ACQ-B pressure treated lumber. Ten fasteners from each sample set were tested. The results, shown in FIG. 9, showed that after 312 hours, the hot dipped galvanized fasteners all displayed red rust (larger than 1 mm²) and the fasteners 10 in accordance with the invention showed none.

Internal testing performed a direct comparison of the fasteners 10 to two samples of hot dipped galvanized fasteners, Fastener A and Fastener B, by driving the all of fasteners in a side by side fashion in the same board. Six samples were made for each comparison test set. The samples with the worst corrosion were removed every 200 hours after being subject to an initial 400 hours of exposure in the salt spray environment. The results are listed in Tables I and II, where I.R=Initial Rust (1 mm²); >15=Greater than 15% Red Rust; >50=Greater than 50% Red Rust:

TABLE I
Salt Spray Exposure from 400 to 800 Hours Results

| | | Fastener A - Hot Dipped | | | Fastener 10 of the | | |
|---|---|---|---|---|---|---|---|
| | | Galvanized Steel | | | Present Invention | | |
| | | (6) Samples Total | | | (6) Samples Total | | |
| Hours | Test Set | I.R | >15 | >50 | I.R | >15 | >50 |
| 400 | 1 | 1 | 2 | 0 | 0 | 0 | 1 |
| 400 | 2 | 2 | 1 | 0 | 1 | 0 | 0 |
| 600 | 1 | 3 | 0 | 0 | 3 | 0 | 1 |
| 600 | 2 | 0 | 0 | 6 | 0 | 1 | 3 |
| 800 | 1 | 0 | 0 | 6 | 2 | 1 | 3 |
| 800 | 2 | 0 | 1 | 5 | 1 | 1 | 4 |

TABLE II
Salt Spray Exposure from 400 to 800 Hours Results

| | | Fastener B - Hot Dipped | | | Fastener 10 of the | | |
|---|---|---|---|---|---|---|---|
| | | Galvanized Steel | | | Present Invention | | |
| | | (6) Samples Total | | | (6) Samples Total | | |
| Hours | Test Set | I.R | >15 | >50 | I.R | >15 | >50 |
| 400 | 1 | 2 | 0 | 1 | 1 | 1 | 1 |
| 400 | 1 | 3 | 0 | 0 | 0 | 0 | 0 |
| 600 | 2 | 2 | 0 | 0 | 1 | 1 | 0 |
| 600 | 1 | 4 | 0 | 0 | 1 | 0 | 0 |
| 800 | 1 | 1 | 0 | 5 | 1 | 2 | 3 |
| 800 | 2 | 2 | 1 | 3 | 1 | 1 | 4 |

In order to understand the comparative performance of the fasteners 10 of the present invention to hot dipped galvanized fasteners, Fastener A and Fastener B, in a shorter exposure time, the test was repeated for an exposure of 200 hours. The results of the test are listed in Tables III and IV, where I.R=Initial Rust (1 MM2); >15=Greater than 15% Red Rust; >50=Greater than 50% Red Rust:

TABLE III
Salt Spray Exposure After 200 Hours Results

| | | Fastener A - Hot Dipped | | | Fastener 10 of the | | |
|---|---|---|---|---|---|---|---|
| | | Galvanized Steel | | | Present Invention | | |
| | | (6) Samples Total | | | (6) Samples Total | | |
| Hours | Test Set | I.R | >15 | >50 | I.R | >15 | >50 |
| 200 | 1 | 0 | 0 | 0 | 0 | 0 | 0 |
| 200 | 2 | 0 | 0 | 0 | 0 | 0 | 0 |

TABLE IV
Salt Spray Exposure After 200 Hours Results

| | | Fastener B - Hot Dipped | | | Fastener 10 of the | | |
|---|---|---|---|---|---|---|---|
| | | Galvanized Steel | | | Present Invention | | |
| | | (6) Samples Total | | | (6) Samples Total | | |
| Hours | Test Set | I.R | >15 | >50 | I.R | >15 | >50 |
| 200 | 1 | 2 | 0 | 1 | 0 | 0 | 0 |
| 200 | 2 | 0 | 0 | 0 | 1 | 1 | 1 |

The conclusion from the internal and third party driven salt spray results is that the fasteners 10 in accordance with the invention surprisingly performed as well as or better than hot dipped galvanized fasteners.

AWPA E 12 Results

Internal AWPA E 12 tests (SFS TL-07682) were performed because there are no building code recognized laboratories that perform this test. The tests were performed in three different pressure treatments at two different retentions (when available) and compared fasteners with a 0.5 mil electrodeposited coating to hot dipped galvanized fasteners. Overall, the fasteners with a 0.5 mil electrodeposited coating lost, on average, 58% less thickness than the hot dipped galvanized fasteners. Based on this data, it is projected that the fastener in accordance with this invention may be able to use a zinc coating of 60% less thickness, as compared to hot dipped galvanized fasteners, to get similar expected service life.

While preferred embodiments of the invention have been shown and described, it is evident that variations and modifications are possible that are within the spirit and scope of the preferred embodiments described herein. The disclosed embodiments have been provided solely to illustrate the principles of the invention and should not be considered limiting in any way.

1. A package of collated galvanized carbon steel fasteners suitable for use in adverse environmental conditions, the package comprising:
a plurality of fasteners, each fastener comprising
a head having a top surface suitable for being driven into a flush relationship with a substrate, and a bottom head surface that contacts the substrate;
a single elongate shank integral with the head and extending from the bottom head surface, the elongate shank including a tip opposite the head;
said head and integral shank formed from carbon steel; and
an electrodeposited coating deposited directly on the carbon steel head and shank, the electrodeposited coating comprising zinc and having an average thickness of greater than about 1.0 mil,
wherein at least a portion of the top surface of the carbon steel head is textured to improve adhesion between the electrodeposited coating and the top surface; and
an attachment structure constructed and arranged to temporarily attach the plurality of fasteners into the package in which the fasteners are in collated relation.

2. The package of collated fasteners of claim 1, wherein the average thickness of the electrodeposited coating is about 1.2 mils to about 2.0 mils.

3. The package of collated fasteners of claim 1, wherein each fastener further comprises a second coating deposited on the electrodeposited coating, the second coating comprising chromate and having an average thickness of less than about 0.05 mil.

4. The package of collated fasteners of claim 3, wherein the average thickness of the second coating is about 0.01 mil to about 0.05 mil.

5. The package of collated fasteners of claim 3, wherein each fastener further comprises a polymer coating deposited on the second coating.

6. The package of collated fasteners of claim 1, wherein the fastener is a nail.

7. The package of collated fasteners of claim 1, wherein the collated relation is a parallel substantially longitudinally coextensive relation.

8. The package of collated fasteners of claim 7, wherein the attachment structure comprises a pair of frangible wires welded to the shank of each fastener of the package.

9. The package of collated fasteners of claim 1, wherein the shank is substantially smooth.

10. The package of collated fasteners of claim 1, wherein the shank further includes a plurality of surface deformations formed on the shank.

11. The package of collated fasteners of claim 10, wherein the surface deformations of each fastener comprise a plurality of spiral flutes extending radially outwardly from the shank.

12. The package of collated fasteners of claim 10, wherein the surface deformations of each fastener comprise a plurality of rings extending radially outwardly from the shank.

13. In combination:
at least one piece of pressure treated wood; and
a galvanized carbon steel fastener comprising
a head having a top surface suitable for being driven into a flush relationship with an exterior surface of a substrate, and a bottom surface for engaging the exterior surface of the substrate;
a single elongate shank integral with the head and extending from the bottom surface of the head, the shank comprising a tip opposite the head;
said head and integral shank formed from carbon steel; and
an electrodeposited coating deposited directly on a surface of the carbon steel head and shank, the electrodeposited coating comprising zinc and having an average thickness of greater than about 1.0 mil,
wherein at least a portion of the top surface of the carbon steel head is textured to improve adhesion between the electrodeposited coating and the top surface.

14. The combination as defined in claim 13, wherein the average thickness of the electrodeposited coating is about 1.2 mils to about 2.0 mils.

15. The combination as defined in claim 13, wherein each fastener further comprises a second coating deposited on the electrodeposited coating, the second coating comprising chromate and having an average thickness of less than about 0.05 mil.

16. The combination as defined in claim 15, wherein the average thickness of the second coating is about 0.01 mil to about 0.05 mil.

17. The combination as defined in claim 15, wherein each fastener further comprises a polymer coating disposed on the second coating.

18. The combination as defined by claim 13, wherein the shank is substantially smooth.

19. The combination as defined by claim 13, wherein the shank further comprises a plurality of surface deformations formed on the shank.

20. The combination as defined by claim 19, wherein the surface deformations comprise a plurality of spiral flutes extending radially outwardly from the shank.

21. The combination as defined by claim 19, wherein the surface deformations comprises a plurality of rings extending radially outwardly from the shank.

22. The combination as defined by claim 13, wherein the fastener is a nail.

23. The combination as defined by claim 13, wherein the fastener is a screw.

24. The combination as defined by claim 13, wherein the pressure treated wood includes chromated copper arsenate.

25. The combination as defined by claim 13, wherein the pressure treated wood includes ammoniacal copper quat.

26. The combination as defined by claim 13, wherein the pressure treated wood includes copper boron azole.

27. A galvanized carbon steel fastener for use in adverse environmental conditions, the fastener comprising:
a head having a top surface suitable for being driven into a flush relationship with an exterior surface of a substrate, and a bottom surface for engaging the exterior surface of the substrate;
a single elongate shank integral with the head and extending from the bottom surface of the head, the shank comprising a tip opposite the head;
said head and integral shank formed from carbon steel; and
an electrodeposited coating deposited directly on a surface of the carbon steel head and shank, the electrodeposited coating comprising zinc and having an average thickness of greater than about 1.0 mil,
wherein at least a portion of the top surface of the carbon steel head is textured to improve adhesion between the electrodeposited coating and the top surface.

28. The fastener of claim 27, further comprising a second coating deposited on the electrodeposited coating, the second coating comprising chromate and having an average thickness of less than about 0.05 mil.
